(19) United States
(12) Patent Application Publication
(10) Pub. No.: US 2024/0034287 A1
(43) Pub. Date: Feb. 1, 2024

(54) Method for Monitoring Traction for a Motor Vehicle

(71) Applicant: Bayerische Motoren Werke Aktiengesellschaft, Müenchen (DE)

(72) Inventor: Florian HUELSMANN, Muenchen (DE)

(21) Appl. No.: 18/266,155

(22) PCT Filed: Dec. 2, 2021
(86) PCT No.: PCT/EP2021/084008

§ 371 Date: Jun. 8, 2023

(30) Foreign Application Priority Data
Jan. 18, 2021 (DE) 10 2021 100 894.8

(51) Int. Cl. B60T 8/17; B60T 8/175

(52) U.S. Cl. CPC B60T 8/1706; B60T 8/175

(57) ABSTRACT

The present subject matter relates to monitoring traction for a motor vehicle. A vehicle speed and a circumferential speed of the at least one driven wheel are sensed using sensors of the motor vehicle. A control deviation is determined based on a difference of a setpoint wheel slip and an actual wheel slip. The control deviation is input to the PID traction controller. A slip acceleration is determined based on a difference of a wheel acceleration of the at least one driven wheel and a vehicle acceleration determined from the sensed vehicle speed and a circumferential speed of the at least one driven wheel. Using the PID traction controller, a drive torque of the at least one driven wheel is determined from a sum of a P-component, an I-component, and a D-component of the PID traction controller. The drive torque back to the at least one driven wheel.

### BACKGROUND AND SUMMARY OF THE INVENTION

The present subject matter relates to a method for traction control for a motor vehicle, in particular, a single-track motor vehicle, with a PID traction controller for controlling a drive slip K of at least one driven wheel.

The core constituent part of a traction control system is the slip controller. This controls the drive slip of the rear tire by way of adaptation of the engine torque and therefore adaptation of the drive torque of at least one driven wheel. The input variables of the slip controller are the actual slip and the setpoint slip of the at least one driven wheel. Here, the actual slip is calculated from the vehicle speed and the circumferential speed of the at least one driven wheel. The setpoint rear wheel slip is determined on the basis of the current driving state such as, for example, the tilted position and the speed of the motorcycle, and represents the slip which is to be adjusted by way of the slip controller in order to obtain vehicle stability.

The difference of the setpoint slip in the actual slip results in the control deviation. This serves as an input variable of an electronic PID controller. The calculation is subsequently carried out in the electronic PID controller as to which drive torque of the at least one driven wheel has to be set, in order to minimize the control deviation. A PID controller (proportional-integral-derivative controller) consists of the components of a P-part, an I-part and a D-part, and can be defined with both a parallel structure or a series structure. Here, the P-part has a proportional transfer behavior, and the P-component accordingly consists exclusively of a proportional component of a gain and is therefore proportional with its output signal to the input signal. The I-part has an integrative transfer behavior, and the I-component accordingly acts on the manipulated variable by way of temporal integration of the control deviation. Furthermore, the D-part has a differentiating transfer behavior, and does not react to the level of the control deviation, but rather to its speed of change. Accordingly, the D-component is dependent on the speed of change of the control deviation.

In a PID controller according to the prior art, the D-component is calculated from the gradient of the control deviation which, in addition to the vehicle acceleration and wheel acceleration, is decisively dependent on the vehicle speed. As a result, in the case of a constant slip acceleration, the D-proportion of a PID controller according to the prior art becomes smaller, the higher the vehicle speed. This ultimately leads to it being possible for the D-factor of the electronic PID controller to be set in an optimum manner only to one speed, which leads to an impaired control behavior at other speeds. As an alternative, the D-factor can be adapted using a characteristic curve plotted against speed, in order to always set the optimum factor for the respective speed. This is highly complex in practice, however, since the optimum D-factor has to be determined for a multiplicity of speeds.

It is therefore an object of the present subject matter to provide a method for traction control for a motor vehicle, in particular a single-track motor vehicle, with a PID traction controller for controlling a drive slip K of at least one driven wheel, in the case of which method the control behavior is improved and a determination of the corresponding D-factor is optimized.

This object is achieved by way of the combination of features according to patent claim 1.

According to the present subject matter, a method for traction control for a motor vehicle, in particular a single-track motor vehicle, is proposed with a PID traction controller for controlling a drive slip K of at least one driven wheel, in the case of which method a control deviation Kₑᵣᵣ is used as input variable of the electronic PID traction controller 2, which control deviation Kₑᵣᵣ is determined using a difference of a setpoint wheel slip Kₛₒₗₗ and an actual wheel slip Kᵢₛₜ. The electronic PID traction controller 2 determines a drive torque M_{AR,PID} of the at least one driven wheel from a sum of a P-component M_{AR,P}, an I-component M_{AR,I} and a D-component M_{AR,D} of the electronic PID traction controller 2 and provides it back to drive the at least one driven wheel. Here, the D-component M_{AR,D} of the electronic PID traction controller 2 is determined using a slip acceleration α_{K}, and the slip acceleration α_{K} is determined using a difference of a wheel acceleration d_{VAR}/dt of the at least one driven wheel and a vehicle acceleration d_{VFZG}/dt.

In this way, an improvement in the control speed and a simplification of the parameterization capability of the electronic PID controller are achieved. It is advantageous here that the D-component of a PID controller serves to damp the control loop. In the case of the slip regulator, the D-proportion M_{AR,D} is intended to counteract a change in the control deviation d_{Kerr}/dt. Precisely the proportion of the drive torque of the at least one driven wheel which leads to excess acceleration of the at least one driven wheel is intended to be compensated for physically by way of the D-component. The excess acceleration of the at least one driven wheel α_{K} is the difference of the vehicle acceleration (intended acceleration) and the wheel acceleration of the at least one driven wheel. The product of the undesired wheel acceleration α_{K} and the mass moment of inertia of the at least one driven wheel and drive train, which is constant, results in precisely the excess drive torque of the at least one driven wheel which is intended to be compensated for by way of the D-component.

In one advantageous design variant, it is provided that the P-component M_{AR,P}, the I-component M_{AR,I} and the D-component M_{AR,D} of the electronic PID traction controller 2 are multiplied in each case with a factor for parameterization of the electronic PID traction controller 2. It is favorable here that the optimum parameterization of the D-factor is directly proportional to the mass moment of inertia and is therefore constant. As a result of the implementation of the slip acceleration as D-component, the optimum D-factor kD has to be determined only once and supplies the optimum D-proportion independently of the vehicle speed.

It is provided in one example of the present subject matter that the I-proportion M_{AR,I} of the electronic PID traction controller 2 is determined using an integration of the control deviation Kₑᵣᵣ.

Furthermore, one example is favorable, in the case of which the traction controller controls the drive slip using adaptation of an engine rotational speed, as a result of which the drive torque M_{AR,PID} of the at least one driven wheel is changed. As a result, the method for traction control or the electronic PID traction controller 2 intervenes in the engine controller and controls the slip in order to regulate the drive slip K of at least one driven wheel.

In one preferred example of the present subject matter, the actual wheel slip Kᵢₛₜ is determined using a vehicle speed v_{FZG} and a circumferential speed v_{AR} of the at least one driven wheel.

According to the present subject matter, it is provided in one advantageous variant that the setpoint wheel slip Kₛₒₗₗ is determined on the basis of a current vehicle state. Here, the current vehicle state considers at least a speed and/or a tilted position of the motor vehicle. It is advantageous here that the current vehicle data are used and considered to determine the setpoint wheel slip, as a result of which the traction control is optimized.

In one design variant, the method according to the present subject matter determines an excess drive torque M_{ARü}, bringing about the slip acceleration, of the at least one driven wheel using a multiplication of the slip application α_{K} and the mass moment of inertia of the at least one driven wheel and drive train J_{AR+Antrieb}. It is favorable here that this excess drive torque of the at least one driven wheel is intended to be compensated for using the D-component and, as a consequence, the optimum parameterization of the D-factor is directly proportional to the mass moment of inertia and is correspondingly constant.

Furthermore, one example is favorable, in the case of which limit values are specified for the control deviation Kₑᵣᵣ, which limit values define a tolerance range. In this way, for example, critical values of a wheel slip which lie outside a corresponding tolerance range can be determined and defined. Here, for example, a control deviation Kₑᵣᵣ of 0 defines a limit value, a control deviation Kₑᵣᵣ≤0 determining a tolerance range, in the case of which the electronic PID traction controller 2 does not control to a drive torque M_{AR,PID} of the at least one driven wheel, and a control deviation Kₑᵣᵣ>0 defining a tolerance range, in the case of which the electronic PID traction controller 2 controls to a drive torque M_{AR,PID} of the at least one driven wheel.

It is provided in a further example of the present subject matter that a warning signal is output on a display of the motor vehicle if the control deviation Kₑᵣᵣ exceeds one of the limit values. As a result, the driver of the motor vehicle can be informed that a limit value or the tolerance range of the wheel slip is being or has been exceeded.

Furthermore, according to the present subject matter, a PID traction controller for controlling a drive slip K of at least one driven wheel of a motor vehicle, in particular of a single-track motor vehicle, is proposed, preferably for carrying out the method in accordance with the preceding disclosure, comprising:
a. sensors for measuring a vehicle speed v_{FZG} and a circumferential speed v AR of the at least one driven wheel, and
b. differentiators for determining the slip acceleration α_{K} using a difference of a wheel acceleration d_{VAR}/dt and a vehicle acceleration d_{FZG}/dt from the sensor data of the vehicle speed v_{FZG} and the circumferential speed v_{AR} of the at least one driven wheel, the slip acceleration α_{K} which is determined by way of the differentiator being used as D-component in the electronic PID traction controller 2 for controlling a drive slip K.

It is advantageous here that the method for traction control for a motor vehicle, in particular for a single-track motor vehicle, can be applied using the corresponding PID traction controller to control a drive slip K of at least one driven wheel.

The features which are disclosed above can be combined in any desired manner, in so far as this is technically possible and they are not inconsistent with one another.

Other advantageous developments of the present subject matter are characterized in the claims and/or will be shown in greater detail in the following description of the present subject matter.

### BRIEF DESCRIPTION OF THE DRAWING

FIG. 1 shows a block circuit diagram of a PID traction controller for controlling a drive slip K of a rear wheel of a motor vehicle.

### DETAILED DESCRIPTION

The FIGURE is diagrammatic by way of example. Identical designations in the FIGURE indicate identical functional and/or structural features.

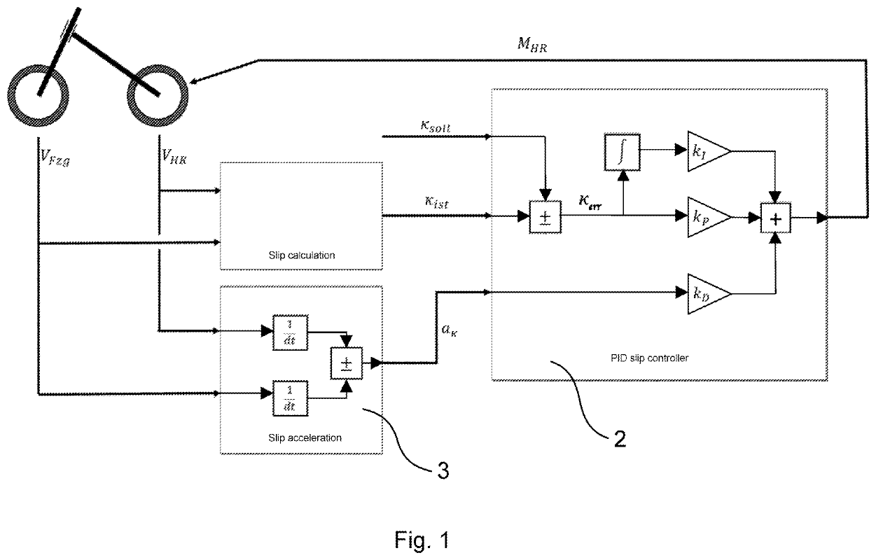

FIG. 1 shows a block circuit diagram of an electronic PID traction controller 2 for controlling a drive slip K of a rear wheel of a motor vehicle. The electronic PID traction controller 2 for controlling the drive slip K of the rear wheel comprises sensors for measuring a vehicle speed v_{FZG} and a rear wheel circumferential speed v_{HR}, and the differentiator module 3 for determining the slip acceleration α_{K} using a difference of a wheel acceleration d_{VHR}/dt and a vehicle acceleration d_{VFZG}/dt from the sensor data of the vehicle speed v_{FZG} and the rear wheel circumferential speed v_{HR}. Furthermore, the slip acceleration α_{K} which is determined by way of the differentiator module 3 is used as de-component in the electronic PID traction controller 2 for controlling a drive slip K.

Moreover, the electronic PID traction controller 2 for carrying out the following method for traction control for a motor vehicle is configured to control a drive slip K of the rear wheel.

In the case of the method, a control deviation Kₑᵣᵣ is used as input variable of the electronic PID traction controller 2, which control deviation Kₑᵣᵣ is determined using a difference of a setpoint rear wheel slip Kₛₒₗₗ and an actual rear wheel slip Kᵢₛₜ, and the electronic PID traction controller 2 determines a rear wheel drive torque M_{HR,PID} of the at least one driven wheel from a sum of a P-component M_{HR,P1}, an I-component M_{HR,I} and a D-component M_{HR,D} of the electronic PID traction controller 2, which is fed back to the rear wheel. Furthermore, the D-component M_{HR,D} of the electronic PID traction controller 2 is determined using a slip acceleration α_{K}, the slip acceleration α_{K} being determined using a difference of a wheel acceleration d_{VHR}/dt and a vehicle acceleration d_{VFZG}/dt.

Moreover, in the case of the method, the P-component MHR,P, the I-component M_{HR,I} and the D-component M_{HR,D} of the electronic PID traction controller 2 are multiplied in each case with a factor for parameterization of the electronic PID traction controller 2. The I-proportion M_{HR,I} of the electronic PID traction controller 2 is determined using an integration of the control deviation Kₑᵣᵣ. Furthermore, the electronic PID traction controller 2 controls the drive slip using adaptation of an engine rotational speed, as a result of which the rear wheel drive torque M_{HR,PID} is changed.

Moreover, the actual rear wheel slip Kᵢₛₜ is determined using a vehicle speed v_{FZG} and a rear wheel circumferential speed v_{HR}, and the setpoint rear wheel slip Kₛₒₗₗ is determined based on a current vehicle state, the current vehicle state considering at least a speed and/or a tilted position of the motor vehicle.

Furthermore, the method comprises that an excess rear wheel drive torque M_{HRü}, bringing about the slip acceleration, is determined using a multiplication of the slip application α_{K} and a mass moment of inertia of the at least one driven wheel and drive train J_{AR+Antrieb}.

The term module (and other similar terms such as unit, subunit, submodule, etc.) in the present disclosure may refer to a software module, a hardware module, or a combination thereof. Modules implemented by software are stored in memory or non-transitory computer-readable medium. The software modules, which include computer instructions or computer code, stored in the memory or medium can run on a processor or circuitry (e.g., ASIC, PLA, DSP, FPGA, or other integrated circuit) capable of executing computer instructions or computer code. A hardware module may be implemented using one or more processors or circuitry. A processor or circuitry can be used to implement one or more hardware modules. Each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices and stored in memory or non-transitory computer readable medium.

The implementation of the present subject matter is not restricted to the preferred examples specified in the preceding text. Rather, a number of variants are conceivable which use the illustrated solution even in the case of examples of fundamentally different type.

1.-10. (canceled)

11. A method for traction control for a single-track motor vehicle with an electronic PID traction controller for controlling a drive slip K of at least one driven wheel, comprising:
sensing, using sensors of the motor vehicle, a vehicle speed v_{FZG} and a circumferential speed v_{AR} of the at least one driven wheel;
determining a control deviation Kₑᵣᵣ based on a difference of a setpoint wheel slip Kₛₒₗₗ and an actual wheel slip Kᵢₛₜ;
inputting the control deviation Kₑᵣᵣ to the PID traction controller;
determining a slip acceleration α_{K} based on a difference of a wheel acceleration d_{VAR}/dt of the at least one driven wheel and a vehicle acceleration d_{VFZG}/dt determined from the sensed vehicle speed v_{FZG} and a circumferential speed v_{AR} of the at least one driven wheel;
determining a D-component M_{AR,D} of the PID traction controller based on the slip acceleration α_{K},
determining, using the PID traction controller, a drive torque M_{AR,PID} of the at least one driven wheel from a sum of a P-component M_{AR,P}, an I-component M_{AR,I}, and the D-component M_{AR,D} of the PID traction controller; and
providing the drive torque M_{AR,PID} back to the at least one driven wheel.

12. The method according to claim 11, further comprising:
multiplying each of the P-component M_{AR,P}, the I-component M_{AR,I} and the D-component M_{AR,D} of the PID traction controller with a factor for parameterization of the PID traction controller.

13. The method according to claim 11, further comprising:
determining the I-component M_{AR,I} of the PID traction controller by integrating the control deviation Kₑᵣᵣ.

14. The method according to claim 11, further comprising:
controlling, by the PID traction controller, a drive slip by adapting an engine rotational speed to change the drive torque M_{AR,PID} of the at least one driven wheel.

15. The method according to claim 11, further comprising:
determining the actual wheel slip Kᵢₛₜ by the vehicle speed v_{FZG} and the circumferential speed v_{AR} of the at least one driven wheel.

16. The method according to claim 11, further comprising:
determining the setpoint wheel slip Kₛₒₗₗ based on a current vehicle state based on at least a speed and/or a tilted position of the motor vehicle.

17. The method according to claim 11, further comprising:
determining an excess drive torque M_{ARû} that causes the slip acceleration of the at least one driven wheel being by multiplying the slip acceleration α_{K} and a mass moment of inertia of the at least one driven wheel and drive train J_{AR+Antrieb}.

18. The method according to claim 11, further comprising:
specifying limit values for the control deviation Kₑᵣᵣ, wherein
the limit values define a tolerance range.

19. The method according to claim 18, further comprising:
outputting a warning signal on a display of the motor vehicle if the control deviation Kₑᵣᵣ exceeds one of the limit values.

20. A PID traction controller for controlling a drive slip K of at least one driven wheel of a single-track motor vehicle, comprising:
a vehicle speed sensor to measure a vehicle speed v_{FZG};
a circumferential speed sensor to measure a circumferential speed VAR of the at least one driven wheel; and
a plurality of differentiators to determine a slip acceleration α_{K} by based on a difference of a wheel acceleration D_{VAR}/dt and a vehicle acceleration d_{FZG}/dt based on the vehicle speed sensor and the circumferential speed sensor, wherein
the slip acceleration α_{K} is as D-component in the PID traction controller to control a drive slip K of the at least one driven wheel.
